(19) United States
(12) Patent Application Publication
(10) Pub. No.: US 2023/0257163 A1
(43) Pub. Date: Aug. 17, 2023

(54) MULTIPURPOSE CONTAINER SYSTEM

(71) Applicants: Joseph R. Fleherty, New Fairfield, CT (US); Bart Flaherty, New Fairfield, CT (US); Emma Flaherty, New Fairfield, CT (US); Joseph Flaherty, II, New Fairfield, CT (US)

(72) Inventors: Joseph R. Fleherty, New Fairfield, CT (US); Bart Flaherty, New Fairfield, CT (US); Emma Flaherty, New Fairfield, CT (US); Joseph Flaherty, II, New Fairfield, CT (US)

(21) Appl. No.: 16/206,952

(22) Filed: Nov. 30, 2018

(51) Int. Cl. B65D 25/20; B65D 1/12; B65D 1/34; B65D 25/28; B65D 43/02; B65D 51/24; B65D 81/38

(52) U.S. Cl. CPC B65D 25/20; B65D 1/12; B65D 1/34; B65D 25/28; B65D 43/0202; B65D 51/24; B65D 81/38; B65D 2525/287; B65D 2543/00092

(57) ABSTRACT

A container system includes a container having a top and a bottom, with an attachment collar secured to the container, the attachment collar providing for the attachment of one or more accessories to the container.

### BACKGROUND

### 1. Field of the Invention

The present invention relates generally to containers and bucket, and more specifically, to a multipurpose container system for a plurality of uses, including convenient transportation of fishing equipment, sporting equipment, camping equipment, medical equipment, construction equipment and the like. The present invention provides a number of useful features, that can easily be implemented by the user depending on the current needs.

### 2. Description of Related Art

Containers and buckets are well known in the art and provide a number of uses. For example, FIG. 1 depicts an isometric view of a bucket 101 having a body 103 with a handle 105 and grip 107 extending therefrom. Bucket 101 can serve many purposes. For example, fishermen commonly use bucket 101 for transportation of bait, rods, tackle, and the like. Sportsmen commonly use bucket 101 for transportation of sporting equipment and the like. The list of additional uses can continue on, including using an inverted bucket for a seat, transportation of items for construction work, storage of one or more items, etc.

Due to the already universal use of buckets and containers, it is desirable to improve the conventional products to make them more versatile, user friendly, and adaptable for a variety of purposes.

It is an object of the present invention to provide a container with one or more attachment points and a container system in which the container includes an attachment mechanism to allow the user to attach one or more accessories. This embodiment of the present invention provides use in transportation, storage, and use of tools/accessories and the like.

It is another object of the present invention to provide a container system in which one or more trays can be easily stacked and removed from an interior of the container, thereby providing the user with additional organized storage. This embodiment can easily be adapted for use in a plurality of industries.

It is yet another object of the present invention to provide a container system with an improved handle that provides for proper support to the container, thereby preventing the container from tilting or swaying excessively during transportation.

It should be appreciated that other objectives, uses, and benefits of the invention contained herein will become apparent throughout the description. It should further be appreciated that the features discussed herein can be interchanged between embodiments as desired by the user.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an isometric of a common container system;

FIG. 2 is an isometric view of a container system in accordance with a preferred embodiment of the present application;

FIG. 3 is an isometric view of a tray for use with the container system in accordance with the present application;

FIG. 4 is an isometric view of a second tray for use with the container system in accordance with the present application;

FIG. 5 is a top view of a container of FIG. 2 showing a plurality of attachment channels in accordance with a preferred embodiment of the present application;

FIG. 6 is a top view of one of the attachment channels demonstrating a taper to receive an attachment rail associated with an accessory therein;

FIG. 7 is an isomeric view of a first accessory with a first embodiment of an attachment rail for use with the system of FIG. 2;

FIG. 8 is an isometric view of a second accessory with second embodiment of an attachment rail for use with the system of FIG. 2;

FIG. 9 is an isometric view of a third accessory for use with the system of FIG. 2;

FIG. 10 is a front isometric view of a universal attachment for use with the system of FIG. 2;

FIG. 11 is a rear isometric view of the universal attachment of FIG. 10;

FIG. 12 is an isometric view of an alternative embodiment of a container system in accordance with the present application;

FIG. 13 is an isometric view of an alternative embodiment of a container system in accordance with the present application;

FIG. 14 is an isometric view of an alternative embodiment of a container system in accordance with the present application;

FIG. 15 is an isometric view of an alternative embodiment of a container system in accordance with the present application;

FIG. 16 is an isometric view of an alternative embodiment of a container system in accordance with the present application;

FIG. 17 is an isometric view of an alternative embodiment of a container system in accordance with the present application;

FIG. 18 is an isometric view of an alternative embodiment of a container system in accordance with the present application;

FIG. 19 is an isometric view of an alternative embodiment of a container system in accordance with the present application;

FIG. 19B is a side view of an alternative embodiment of a container system in accordance with the present application;

FIGS. 20A and 20B are partial side views showing a fastening apparatus of the container system of FIG. 19;

FIG. 21 is a bottom view of an embodiment of the container of FIG. 20;

FIG. 22 is a side view of a reversible seat configured to secure to one or more of the containers of the embodiments of the present invention;

FIGS. 23A and 23B are side views of a stacked tray system for use in any of the container embodiments of the present application; and

FIGS. 24A and 24B are tops view of a tray having two halves for use in any of the container embodiments of the present application.

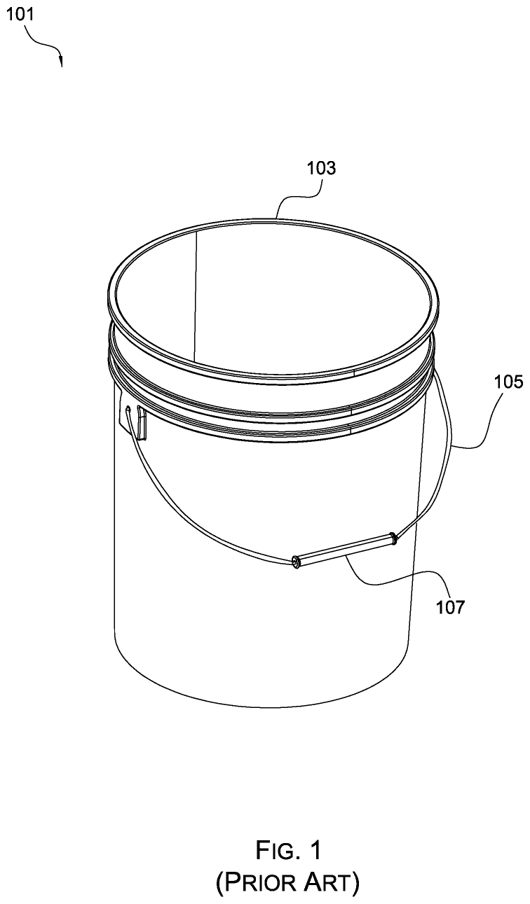

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional bucket and container systems. Specifically, the present invention provides for various container systems with an exterior attachment system for accessories, one or more organized trays for storage within the container, an improved carrying handle, and a variety of other features that improve the use and functionality of a container. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

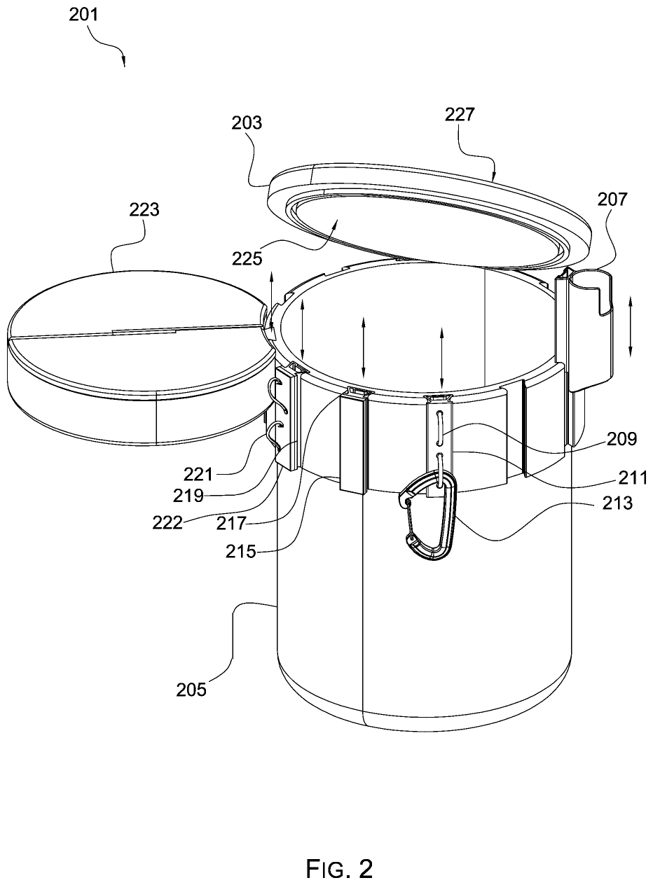

Referring now to the drawings wherein like reference characters identify corresponding or similar elements throughout the several views, FIGS. 2-25 depict various views of a plurality of embodiments of a container system in accordance with the present application. It should be appreciated that the various embodiments provide improved functionality, and a plurality of uses associated with a container. It should be appreciated that although the present figures depict a bucket, namely a bucket similar to a conventional five gallon bucket, the system is adaptable for use with various containers, sizes, and the like.

In FIG. 2, a first embodiment of a container system 201 is shown having a container 205, such as a bucket, and an attachment collar 500, with a plurality of channels 503 configured to receive a plurality of accessories via one or more rails, as will be discussed in more detail. The present application is directly broadly to a container having an attachment means, thereby allowing for a user to easily attach one or more accessories to a container based on the needs of the user. It should be appreciated that the present application uses the term “collar” to describe a means of attachment to a container. This term is used broadly to define an element that is either part of a container, or separate from a container, that can receive one or more accessories. The system can utilize generally vertical engagement between the attachment means and one or more accessories, however, it is contemplated that alternative means could be used.

It should be appreciated that one of the unique features believed characteristic of the present invention is the use of a collar configured to receive accessories. This allows a user to manipulate and design their own container system as desired for a specific purpose, such as for a sporting activity, hunting activity, fishing activity, or the like. As will be discussed in greater detail, it is contemplated that the collar and container can be a single piece, however, in alternative embodiments, the collar is removable and/or added to a conventional container or used separately. Further, the collar can be segmented or one piece. It should further be appreciated that although some of the accessories contemplated are discussed herein, this description should not be limiting to the accessories discussed and disclosed, as the size, material, number, form, and use can easily change for various purposes and uses of the container system, while remaining within the scope and protection of this disclosure. It should be appreciated that an accessory can come in multiple pieces and attach to multiplicity of attachment points and once all attached work together for a common function.

The various items are contemplated as some possible accessories: a fishing rod holder, a shelf, a magnetic plate, a cork plate, a strip of hooks attached to a plate, a strip of loops attached to a plate, an ice scoop holder, a can/drink holder, an organizational tray, a bait container, a light, a solar panel, a cell phone holder, a hammer loop, and a wall clip (for garage, pickup truck, boat storage).

System 201 can include a lid 203 configured to attach to the container 205 by one or more means. It is contemplated that the lid can be connected via a hinge or the like, thereby allowing for a pivoting lid. However, in the preferred embodiment, the lid can include one or more surfaces 225, 227 adapted for multiple purposes, wherein the user can remove the lid, flip the lid over, and utilize a different surface. This provides improved functionality over conventional containers in which the lid is merely for closing off the container. It is contemplated that the lid can include padding for a seat, can include a seat back (not shown), can be fully removable from the container, and can include storage or a variety of other features.

System 201 can further include a first accessory 207, which can attach to the collar via a rail or any other means. It should be appreciated that although the present accessories shown include a rail for vertical engagement with a channel, other contemplated means of attachment could be used. This particular accessory 207 can comprise a holder with a cavity extending therethrough and can be used for carrying items such as fishing rods, however, it should be appreciated that the holder can easily be adapted for use as a cup holder, a sporting equipment holder, a cell phone holder, a tool holder, or a variety of other convenient holders, each having a slightly altered shape as is needed and known in the art for the specific purpose.

System 201 can include a second accessory 209, such as a hook, ring, or the like, secured to a plate 211 and thereby configured to receive items such as carabiners 213. A third accessory 215 contemplated is a magnetic plate secured to a rail 217 to engage with one of the channels of the collar. This particular embodiment can be useful for securely receiving metal items, such as fishing hooks, screws, nails, and the like. Yet another accessory 221 contemplated is a cork plate 222 and a rail 219, this allows for the user to engage items such as fish hooks into the cork. Again, it must be understood that the precise form of the accessories can vary.

System 201 can further include a tray 223 with a rail to removably engage with the collar. Tray 223 can take on a number of forms which will be discussed in more detail. The tray 223 can form an interior storage area, can function as a seat, can be configured to secure within the bucket, can be utilized as a small table, and the like.

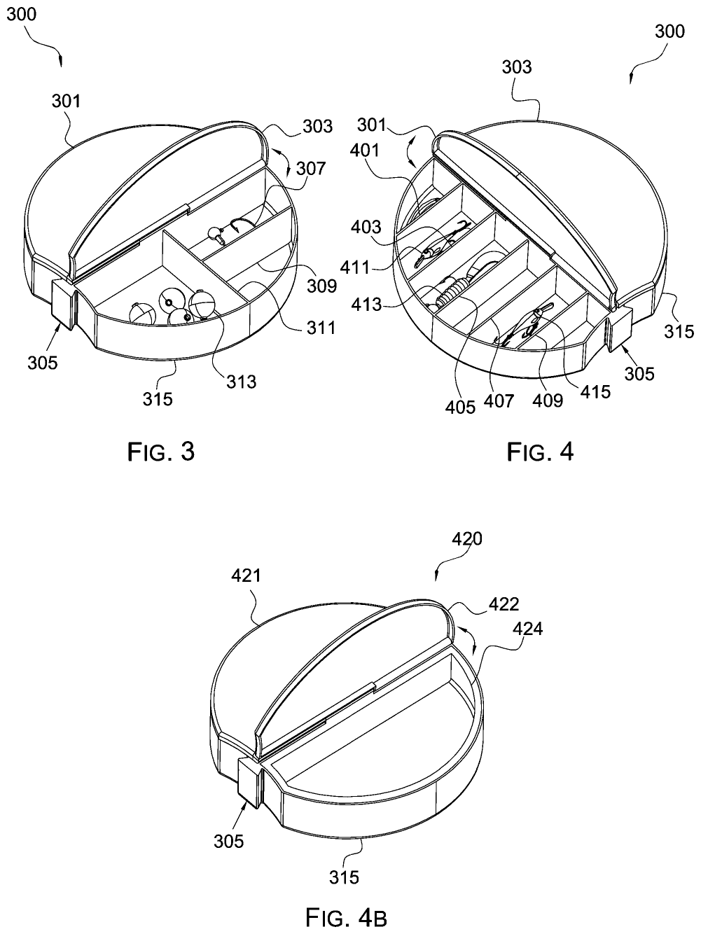

In FIGS. 3 and 4, a first contemplated embodiment of a tray 300 is shown having a first side 301 and a second side 303. The first and second sides 301, 303 open to interior compartments with a plurality of dividers 309, 311, 401, 403, 405, 407, 409. As shown, this provides for a convenient storage area for items 307, 313, 411, 413, 415, such as tackle. The tray is equipped with a rail 305 to engage with channels of collar 500. In one embodiment, a plurality of trays can be stacked together, such as inside of a container, via bottom surfaces 315 of the trays.

In FIG. 4B, an alternative embodiment of a vessel 420 is shown being similar in form to tray 300. Vessel 420 can include one or more lids 421, 422 and can be composed of an insulated material, and or include an insulation layer 424 on the inside of the vessel. This allows for the container to be used as a cooler. The overall size can vary, and the vessel 420 can easily be adapted for storage in the container and securement outside the container.

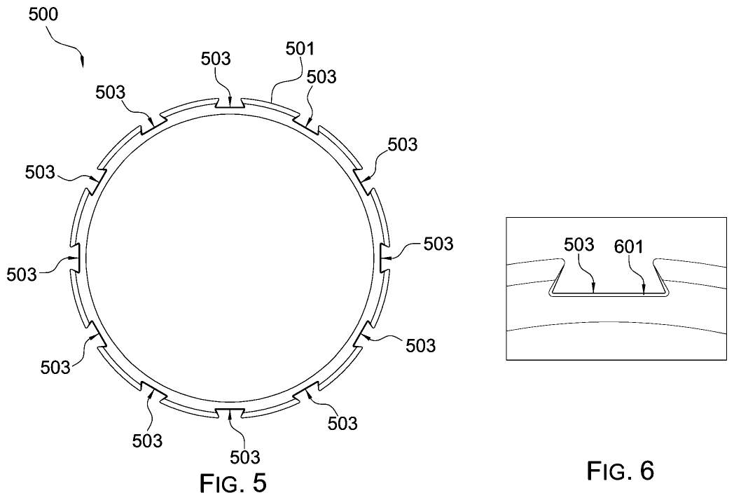

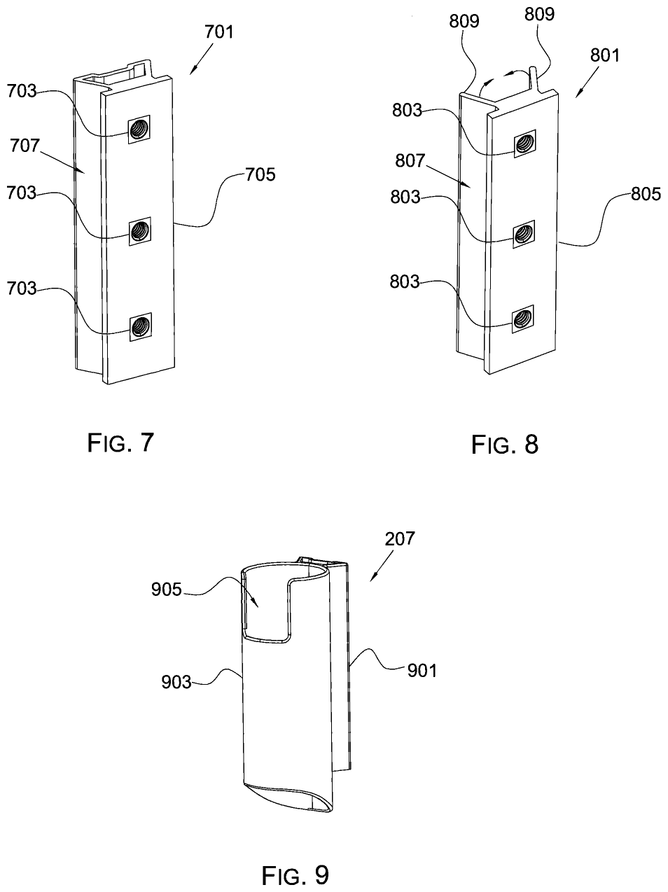

In FIG. 5, a top view further depicts the channels 503 formed in collar 500 and extending inward from an exterior surface 501. The channels 503 can take on a variety of shapes, however one particular shape is shown, this shape being a dove tail and therefore configured to easily receive the rails of the accessories, the rails being corresponding dove tail shapes. As shown in FIG. 6, it is contemplated that towards a base of each of the channels 503, the wall 601 forming the channel can taper inward on any, some, or all of the interior surface, thereby providing a means to receive the rails of the accessories and hold them therein via friction. In the preferred embodiment, the rails have a complimentary shape to the channel. It should be appreciated that in some embodiments the rail can be tapered or straight as desired for functional, aesthetical, or manufacturing considerations.

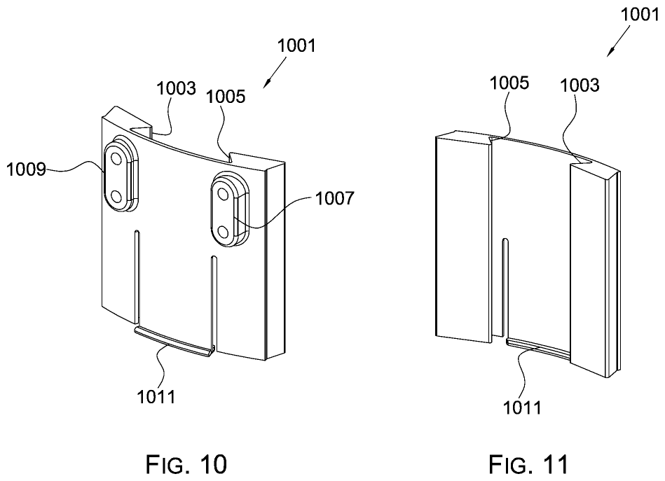

In FIGS. 7 and 8, two embodiments of attachment devices 701, 801, with rails 707, 807 are shown. Attachment device 701 includes a front plate 705 that can have a plurality of attachment locations 703, such as threaded openings/bosses to receive a screw, bolt, or the like. This allows for a universal mount where user supplied devices could be added and also allows for the attachment device 701 to engage with an accessory, such as a holder. In this embodiment, the rail 707 has a dove tail shape that does not taper. This allows for the dove tail shape to engage with the slightly tapered channel, such that the rail will be secured in place via friction. Attachment device 801 includes a front plate 805 with attachment locations 803. In this embodiment, the rail is composed of two protrusions 809, which are flexible to provide for optimal fit within the channel.

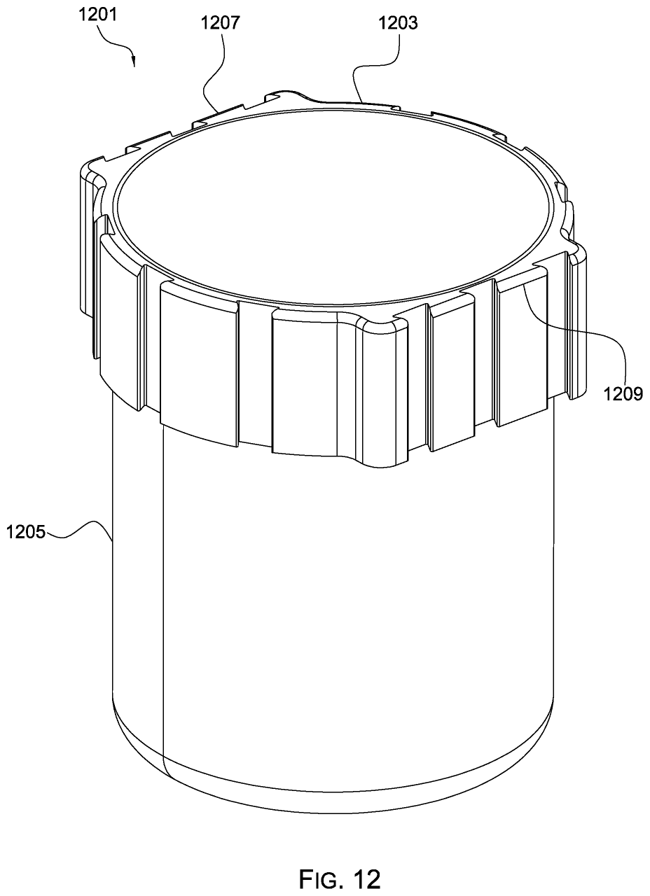

In FIG. 9, an isometric view further depicts the features of holder 207 having a universal mount, holder 207 comprising a body 903 attached to a rail 901 and forming a channel 905 to receive an item (such as a fishing rod) therein. This particular embodiment of a holder can easily be adapted for a cup holder or other item holder.

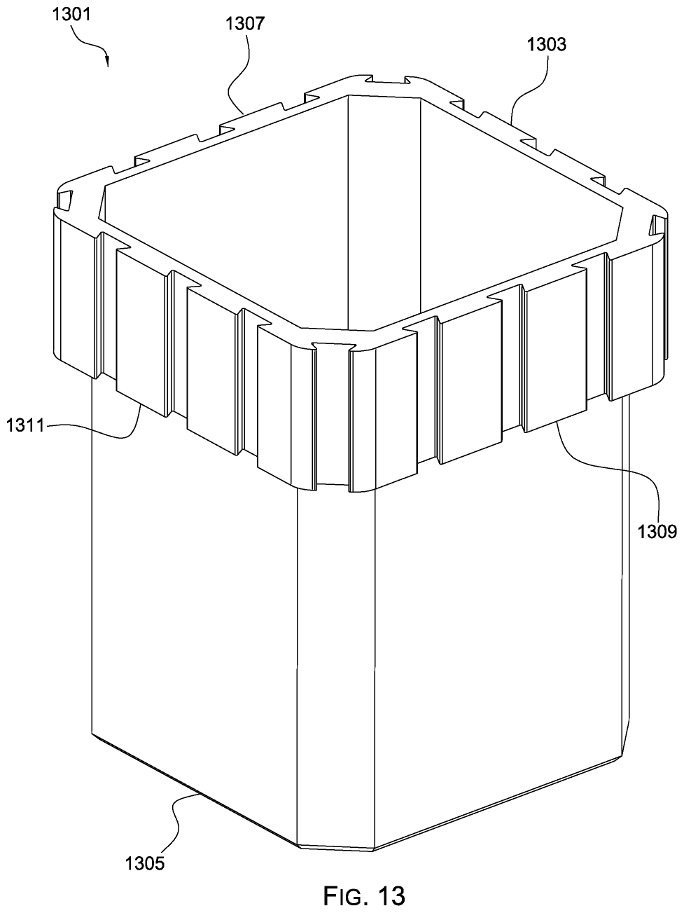

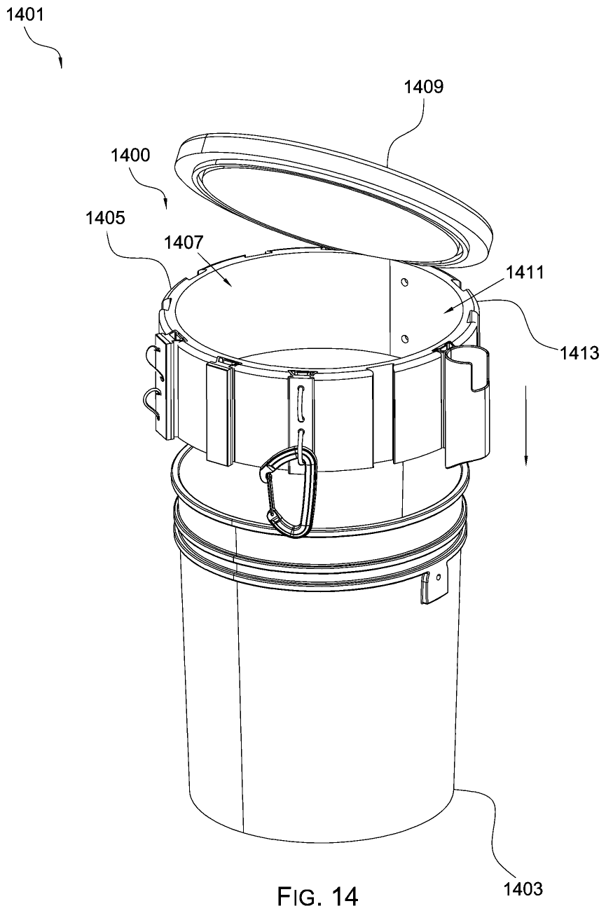

In FIGS. 10 and 11, front and back isometric views of an alternative embodiment of a universal mount 1001 is shown. This provides for a reversed embodiment when compared to the embodiments previously discussed. Mount 1001 can include a channel formed between sides 1005, 1003 to be secured to a rail, wherein the rail would extend from the container and/or collar. This allows for the user to secure anything they like to the collar via one or more attachment devices 1007, 1009. This allows the user to modify the container system per their own liking. This embodiment further depicts a mechanical catch 1011 that can be used to secure the mount 1001 to a rail associated with a collar.

FIG. 12 depicts an alternative embodiment of a container system 1201 in accordance with an alternative embodiment of the present application. Container system 1201 including a container 1205 and a collar 1203 attached thereto. This embodiment includes an alternative shaped collar, having a partially round area and a partially squared/flat end, with one or more dovetails 1207, 1209. This embodiment provides a means for one or more container systems to be secured together via the attachment channels and attachment rails, as discussed herein.

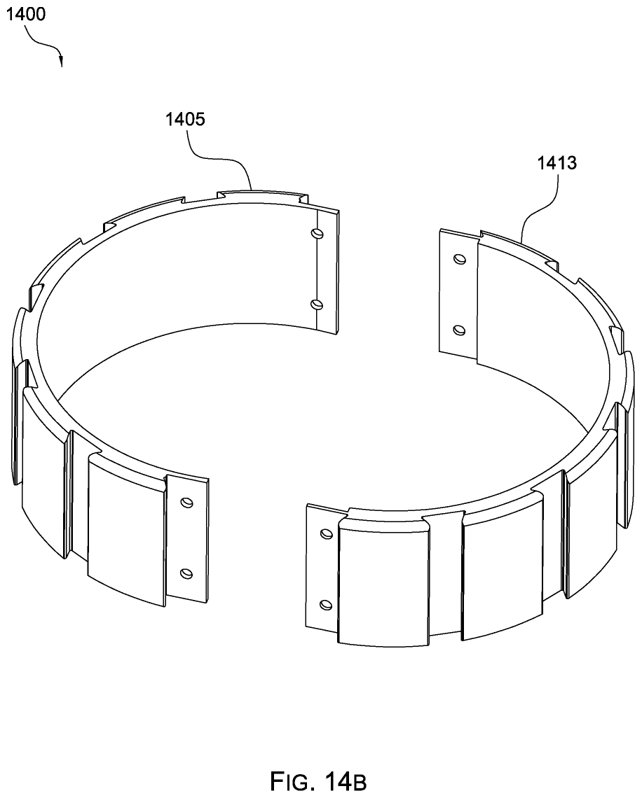

FIG. 13 depicts yet another alternative embodiment of a container system 1301 having a body 1305 and a collar 1303 that is substantially square and includes a plurality of sides 1307, 1309, 1311 having channels formed therein for receiving accessories. It should be appreciated that the features of the various embodiments can be interchanged, and mixed and matched for any functional, aesthetical, and/or manufacturing consideration.

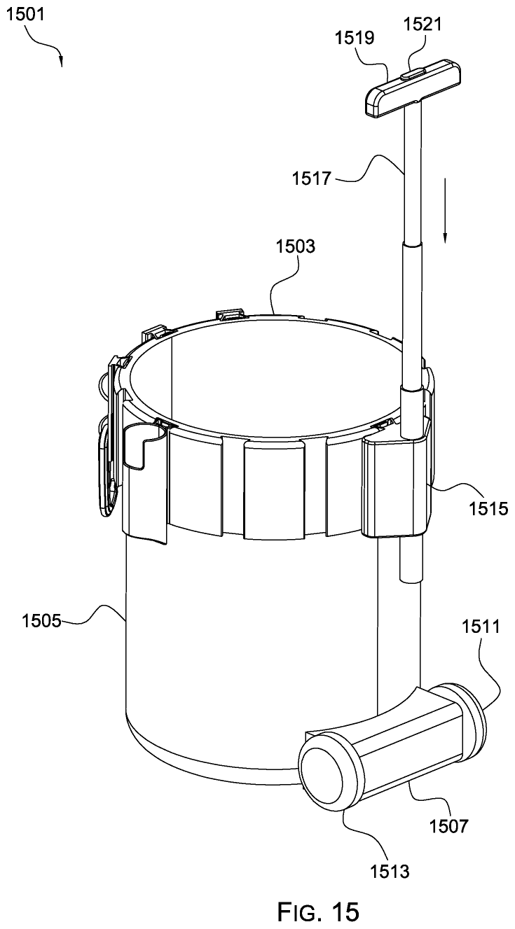

In FIG. 14, an alternative embodiment of a container system 1401 is shown. In this embodiment a container 1403 can engage with a removable collar 1400 having a first portion 1405 removably engaged with a second portion 1413, these two portions coming together to form an interior surface 1407, 1411 that can secure around the exterior of container 1403. The portions of the collar can secure together via screws, bolts, adhesives, or other attachment devices. This embodiment allows for the user to secure a collar to a standard five-gallon bucket if they so choose. The user can then either utilize the container with or without the collar as desired at the time of use. This embodiment can further include a lid 1409. FIG. 14B further depicts collar 1400 shown disconnected into two pieces 1405, 1413 for clarity.

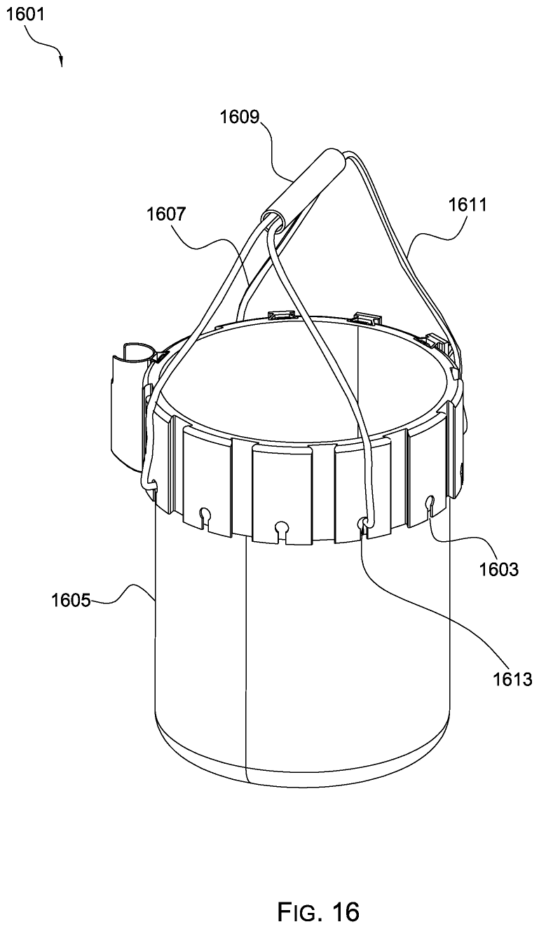

In FIG. 15, yet another alternative embodiment of a container system 1501 is shown. System 1501 including a collar 1503 and a container 1505. In this embodiment, a handle holder 1515 can be engaged to the collar. A handle extension 1517 can extend from the handle holder 1515 to a handle 1519. The extension 1517 can include a release 1521 that allows for the handle to collapse back down to a compact state. The handle can be used to move the container system via wheels 1511, 1513 secured to a wheel base 1507 further secured to the container. It should be appreciated that a plurality of wheels could be incorporated, as are known in the art, for use with the container system. It should further be appreciated that the handle can take on various lengths, materials, and the like. Again, it must be appreciated that the teachings of each embodiment can be interchanged throughout.

In FIG. 16, yet another alternative embodiment of a container system 1601 is shown. System 1601 includes a collar 1603 secured to a container 1605, the collar can be integrated directly into the container or be an independent piece. In this embodiment, the collar 1605 could be minimal and not include any attachment means, or can include the plurality of channels. In this embodiment, a plurality of anchor cutouts 1613 are cut into the collar. The cutouts 1613 can vary in shape and are configured to receive a handle via one or more balls/clasps/hooks/knots or the like. It should be appreciated that alternative attachment means 1614 can be placed along the collar to provide for varying connection points to accomplish load balancing as needed by the user. The handle can include two cords 1607, 1611 that come together within a grip 1609, each cord 1607, 1611 extending to opposing sides, thereby creating a four-point lift on the container. It should be appreciated that this provides for improved stability and manipulation of the container. It is contemplated that the grip 1609 can be padded or firm as desired. In addition, it should be appreciated that the handle is removable via the cords engagement with the anchor cutouts, thereby allowing for the user to decide if they want to use the handle or remove the handle entirely.

It should be appreciated that another unique feature believed characteristic of the present application is the utilization of a four-point connection handle to a container. This can be achieved via anchor cutouts of various shapes, wherein the handle extends upward from four points. Again, it should be appreciated that this feature improves stability and prevents tipping during use of the container.

In FIG. 16B an alternative embodiment is shown, wherein the two handles are removed from two of the attachment points to create a two-point shoulder strap. In FIG. 16C, an alternative embodiment of an attachment device 1618 for use with the handle is shown. Attachment device 1618 includes a hook 1620 which can be rigid or flexible. In a flexible embodiment, the hook 1620 can engage with a ledge 1622 of a clip 1624 to secure the hook in place. The flexible handle 1626 extends from the clip 1624 for use with the container system. The handle end opposite to the attachment device 1618 can have a cinching means to alter the length of the flexible handle 1626. This alternative embodiment provides for securement of the handle to the container, and also allows for the handle to be secured to another object such as a kayak, truck, floor, etc., thereby securing the container in place, such as is convenient for transport.

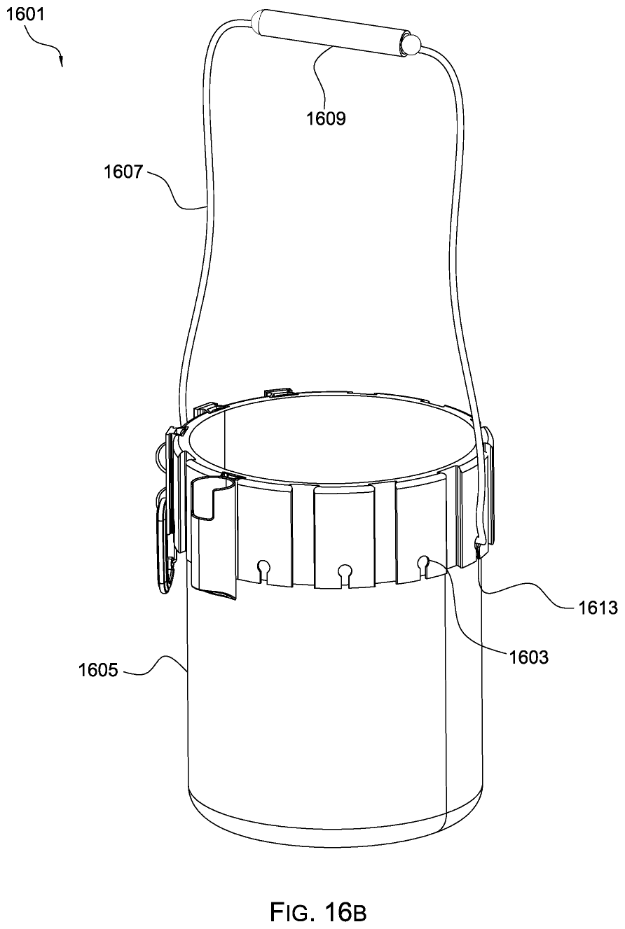

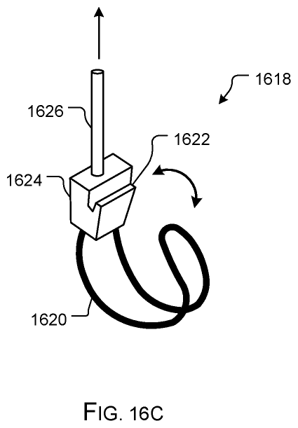

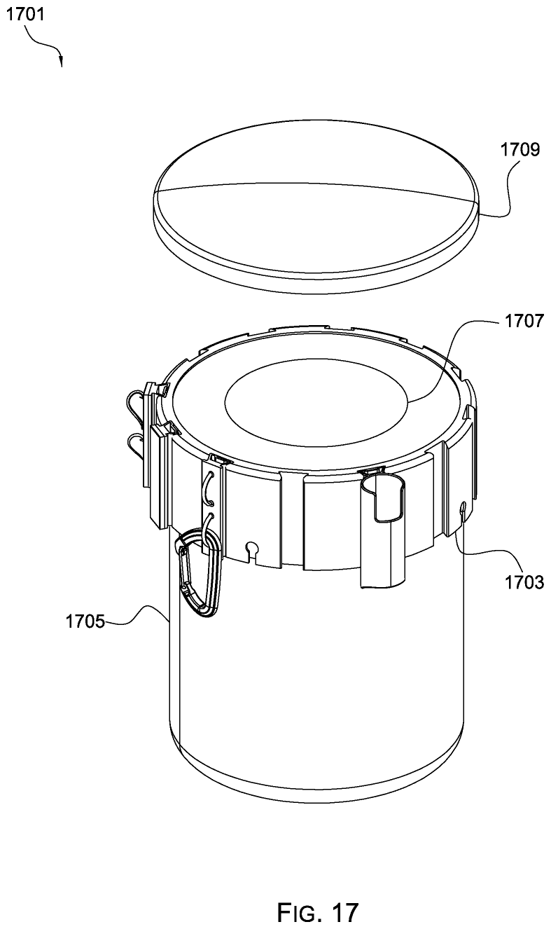

In FIG. 17, yet another alternative embodiment of a container system 1701 is shown. Container system 1701 includes a container 1705 with a collar 1703. In this embodiment, an insulation material 1707, such as a foam, is secured within an interior of the container and configured to be closed via a lid 1709. It should be appreciated that system 1701 can be used as a cooler via the insulation material 1707 or can alternatively be utilized to retain heat. In another embodiment, it is contemplated that an insulated insert can be removably secured in the container and can include a rail to attach to the collar outside of the container.

In FIG. 18, yet another alternative embodiment of a container system 1801 is shown. Container system 1801 includes a container 1805 and collar 1803. In this embodiment, a tray 1809, which can vary in shape, size, number of compartments, and the like, is secured to a pole 1807. This embodiment allows for the pole 1807 and tray 1809 to lift out of the container and pivot to the side, as shown with the arrows. This is achieved via any sort of rail or securement device associated with pole 1807 within the container.

In FIG. 19, yet another alternative embodiment of a container system 1901 is shown. Container system 1901 includes a container 1905 and collar 1903. This embodiment includes a holder 1907 attached to the collar, wherein the holder 1907 is configured to hold one or more sporting equipment 1909, 1911, 1915, such as bats, golf clubs, or the like. This system can further include a base holder 1913 which can be secured directly to the container. It should be appreciated that the holder 1907 and base holder 1913 can vary in size and be configured for various sporting equipment. It is contemplated that an accessory that attaches to the top collar and the base of the container could also be developed and used with the system discussed herein.

In FIG. 19B, yet alternative embodiment of a container system 1922 is shown, having a container 1914 and a collar. This embodiment utilizes a sporting equipment 1920 engaged horizontally with one or more holders 1916, 1918 as a handle for transport of the system, thereby providing improved functionality. It should be appreciated that the holders 1916, 1918 can be engaged with the collar as an accessory previously discussed.

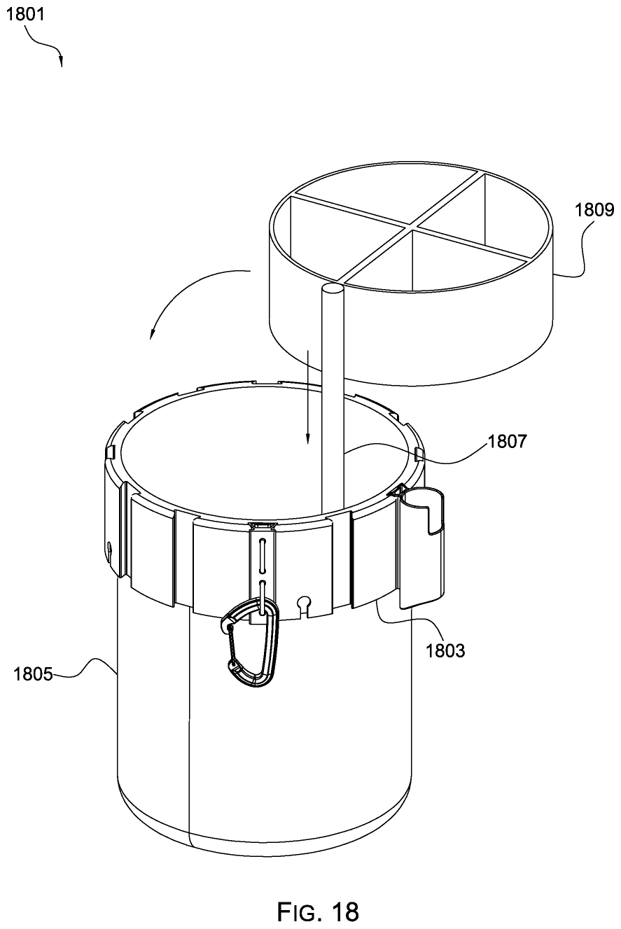

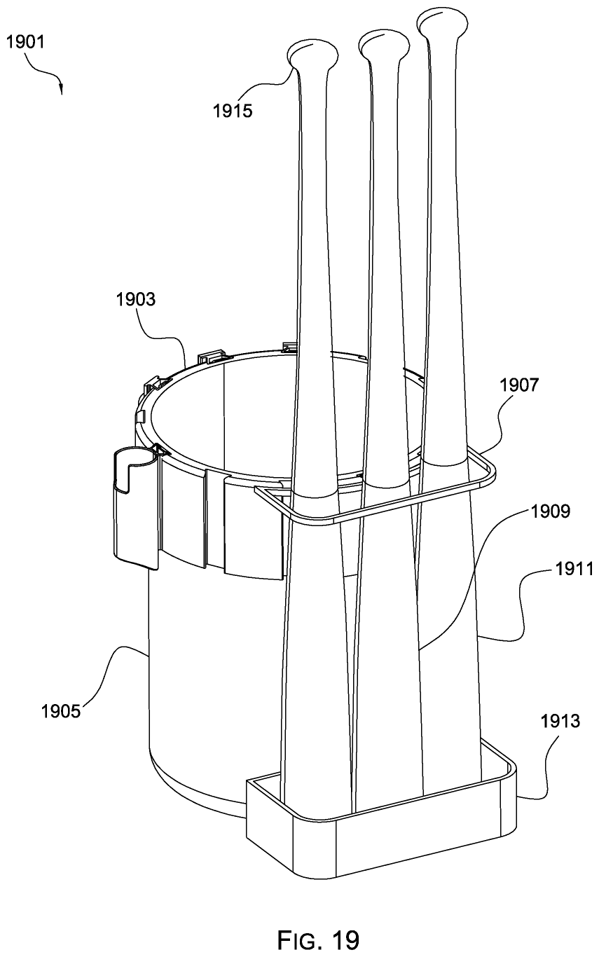

In FIGS. 20A and 20B, side views depict a means of attachment of the base holder 1907 with container 1905. It should be appreciated that alternative systems could easily be used, however, one contemplated embodiment includes one or more fasteners 2001 to extend into a fastener receiver 2003 such as a boss. Alternatively, the fastener 2001 could secure directly to the base 2005 of the container. In some embodiments, the base holder 1907 could include a partial opening 2007 in which the fastener could extend. It is contemplated that screws, bolts, or the like could be used. Alternative embodiments contemplate that adhesives could also be used or other means that don't require puncturing the container in any way. In FIG. 21, a bottom view depicts one orientation of fastener receivers 2003 on container base 2005. It is contemplated that other orientations could be utilized.

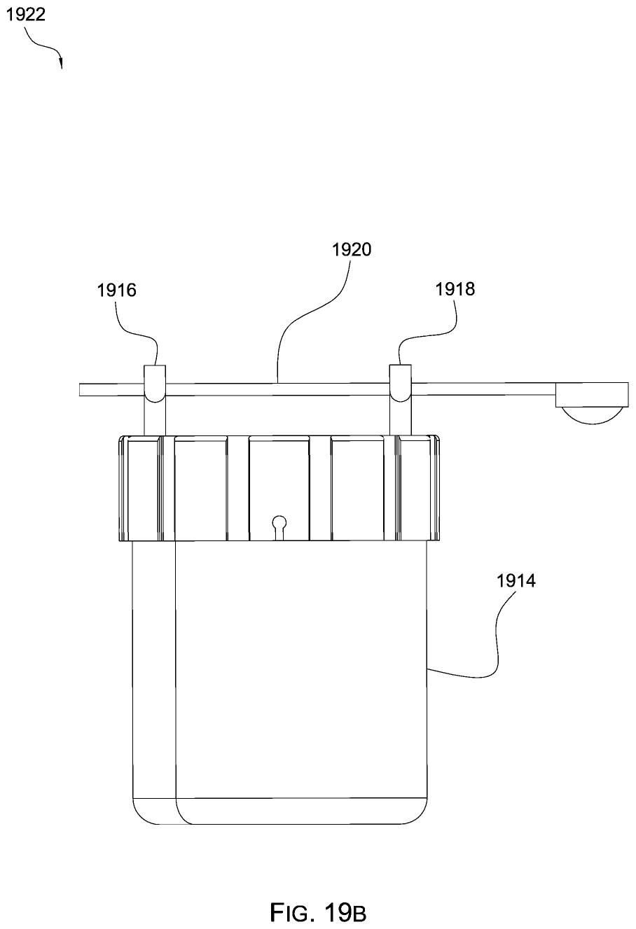

In FIG. 22, an alternative embodiment of a lid 2201 is shown. Lid 2201 can include a first side 2203 and a second side 2205. The lid 2201 has a circumference A, that allows for the lid to secure to the container such that either side 2203, 2205 is available for use. In one embodiment, the first side 2203 is a cushion, thereby providing a seat for the user. It is contemplated that the second side 2205 can be a hard surface such as a cutting board, and can further include a channel 2207, such as to catch liquid during cutting of food products.

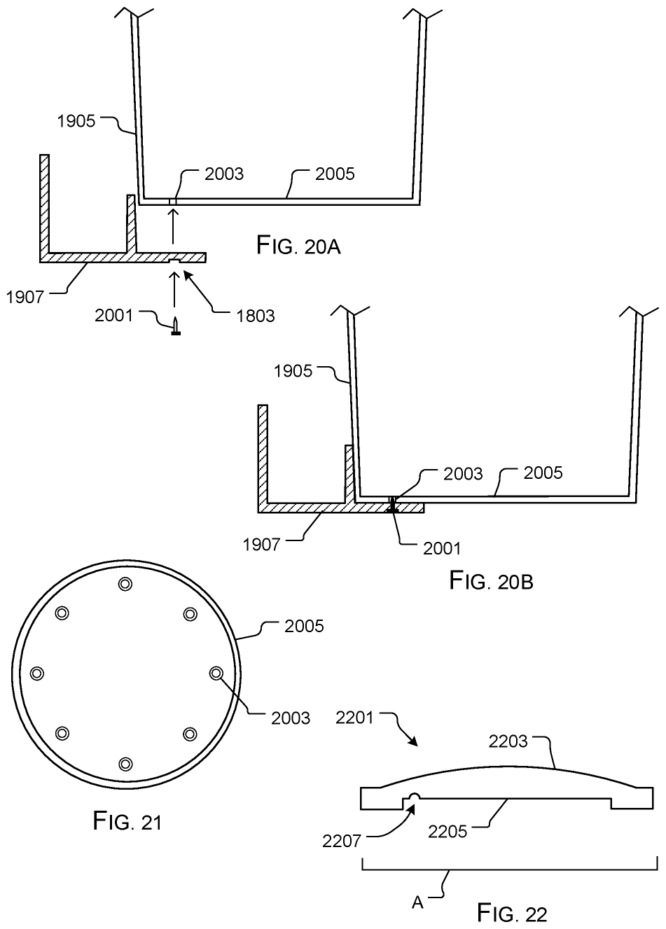

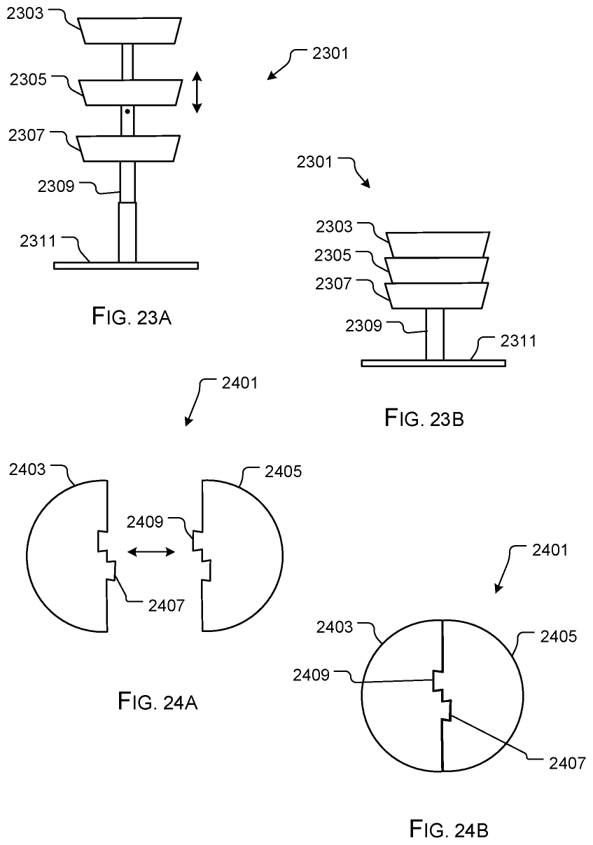

In FIGS. 23A-B, a tray system 2301 is shown. Tray system 2301 can be utilized in any of the container systems discussed herein and includes a plurality of trays 2303, 2305, 2307, which can vary in height, dimensions, internal compartments, and the like, connected via a telescoping extension 2309. It is contemplated that the tray system 2301 can be permanently or removably secured to the base 2311 of a container. The telescoping extension 2309 allows for the trays to be extended out of the container for use, and compacted into the container for storage during non-use.

In FIGS. 24A and 24B, a top view depicts one embodiment of a tray 2401 for use with any of the container systems discussed herein. It should be appreciated that tray 2401 can include interior compartments, can include lids, and can be stackable. This particular embodiment includes a first half 2403 and a second half 2405, each with a rail 2407, 2409. The rails allow for the halves to connect together, and also for the halves to connect to the collar of the container systems.

It should be appreciated that another unique feature believed characteristic of the present invention is the various configuration of one or more trays to be transported and stored within the container, and removable from the container for use. The trays can include interior compartments, handles, or the like for additional organization and use.

The features of the various embodiments disclosed herein can be rearranged throughout the various embodiments to meet the needs of the user.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A container system, comprising:
a container with a top end and a bottom end and forming an interior cavity accessible via an opening;
an attachment collar attached to the container, the attachment collar having:
one or more attachment channels configured to receive one or more accessories via attachment rails;
wherein the one or more accessories are removably attached to the attachment collar for use.

2. The system of claim 1, wherein the attachment collar further comprises:
a first portion and a second portion configured to secure together via an attachment device to form the attachment collar;
wherein the attachment collar is removable from the container.

3. The system of claim 1, further comprising:
a tray having an attachment rail configured to engage with the attachment collar.

4. The system of claim 1, further comprising:
a holder having an attachment rail configured to engage with the attachment collar, the holder having a body forming a cavity.

5. The system of claim 1, further comprising:
a plate having an attachment rail configured to engage with the attachment collar.

6. The system of claim 1, further comprising:
a lid configured to engage with the opening and having a first side and a second side, the first side and second side configured for two different uses.

7. The system of claim 6, wherein the first side includes a seat and the second side includes a cutting board.

8. The system of claim 1, further comprising:
one or more fastener receivers engaged with a base of the container.

9. The system of claim 8, further comprising:
a bottom holder configured to secure to the base of the container via one or more fasteners engaging with the one or more fastener receivers.

10. The system of claim 1, further comprising:
a telescoping handle having a rail to engage with the attachment collar.

11. A container system, comprising:
a container with a top end and a bottom end and forming an interior cavity accessible via an opening;
a tray system configured to be housed within the interior cavity, the tray system having:
a first tray with one or more compartments for storage;
wherein the first tray is removably secured within the interior cavity.

12. The system of claim 11, further comprising:
an attachment collar attached to the container, the attachment collar having:
one or more attachment channels;
the first tray having one or more attachment rails configured to engage with the one or more attachment channels.

13. The system of claim 11, further comprising:
a pole secured to the first tray and engaged within the interior cavity;
wherein the pole is configured to raise and pivot the first tray from the interior cavity.

14. The system of claim 11, further comprising:
a telescoping extension positioned within the interior cavity;
wherein the first tray is configured to engage with the telescoping extension.

15. The system of claim 11, wherein the first tray further comprises:
a first portion and a second portion removably secured together.

16. A container system, comprising:
a container with a top end and a bottom end and forming an interior cavity accessible via an opening;
a collar configured to attach to the container, the collar having one or more anchor cut outs;
a flexible handle configured to engage with the one or more anchor cut outs in one or more configurations for load balancing.

17. The system of claim 16, wherein the flexible handle comprises:
a first elongated cable; and
a second elongated cable;
wherein the first elongated cable and second elongated cable engage via a grip and attach to the container to create the four-point attachment.

18. The system of claim 16, further comprising:
a holder having a rail configured to engage with a channel disposed within the collar.

19. The system of claim 16, further comprising:
an insulation container removably contained within the interior cavity.
